(19) United States
(12) Patent Application Publication
(10) Pub. No.: US 2020/0079359 A1
(43) Pub. Date: Mar. 12, 2020

(54) AUTOMATED PARKING DEVICE AND AUTOMATED PARKING METHOD

(71) Applicant: HONDA MOTOR CO., LTD., Tokyo (JP)

(72) Inventors: Miki TSUJINO, WAKO-SHI (JP); Masashi YOSHIFUKU, WAKO-SHI (JP)

(21) Appl. No.: 16/561,762

(22) Filed: Sep. 5, 2019

(30) Foreign Application Priority Data
Sep. 7, 2018 (JP) 2018-167454

(51) Int. Cl. B60W 30/06; G05D 1/00; B60W 50/14

(52) U.S. Cl. CPC B60W 30/06; G05D 1/0088; G05D 2201/0213; B60W 2050/146; B60W 2550/20; B60W 50/14

(57) ABSTRACT

An automated parking device detects a peripheral environment around a periphery of a host vehicle including parking spaces having obstructions therein, and determines, based on the peripheral environment around the periphery of the host vehicle, a degree of obstruction when parking is attempted in the parking spaces, the automated parking device including selection units which enable the selection of parking in desired parking spaces, and a vehicle control unit which, when a user has selected to park in the parking space having a small inhibitory factor, executes an automated parking operation by causing the user to recognize that parking in the parking space is being performed.

### CROSS-REFERENCE TO RELATED APPLICATION

This application is based upon and claims the benefit of priority from Japanese Patent Application No. 2018-167454 filed on Sep. 7, 2018, the contents of which are incorporated herein by reference.

### BACKGROUND OF THE INVENTION

### Field of the Invention

The present invention relates to an automated parking device and an automated parking method which detect parking spaces around the periphery of a host vehicle, and automatically park the host vehicle within the parking spaces.

### Description of the Related Art

In Japanese Laid-Open Patent Publication No. 2016-215691 (hereinafter referred to as JPA2016-215691), a technique is disclosed in which, when parking of a vehicle is carried out, obstructions (other vehicles, trees, curbstones, utility poles, guide signs, curved road surfaces, road surface irregularities) are detected, and parking of the vehicle in a parking space while avoiding such obstructions is assisted (see paragraphs [0011], [0014], [0015] and [0019] and FIG. 1(b) of JPA2016-215691).

However, when such detected obstructions are uniformly avoided and parking is not carried out, excessive limiting of the parking spaces may occur, and there is a concern of not conforming to the user's intention.

### SUMMARY OF THE INVENTION

The present invention has been devised taking into consideration the aforementioned problems, and has the object of providing an automated parking device and an automated parking method, in which it is possible to expand a scene in which parking is enabled in parking spaces, without excessively limiting the parking spaces due to the presence of obstructions therein.

One aspect of the present invention is an automated parking device that detects a parking space around a periphery of a host vehicle, and automatically parks the host vehicle within the detected parking space, the automated parking device comprising: a peripheral environment detection unit configured to detect a peripheral environment around the periphery of the host vehicle including the parking space and an obstruction within the parking space; a degree of parking obstruction determining unit configured to classify and determine, based on the peripheral environment around the periphery of the host vehicle detected by the peripheral environment detection unit, at least three categories of degree of obstruction when parking of the host vehicle in the parking space is attempted, the categories including a case in which an inhibitory factor is not present and parking is possible, a case in which parking is possible although a small inhibitory factor is present, and a case in which a large inhibitory factor is present and parking is impossible; a selection unit configured to enable selection by a user of parking in the parking space having no inhibitory factor, or parking in the parking space having the small inhibitory factor; and a vehicle control unit configured to control the host vehicle so as to park in the selected parking space, wherein, when the user has selected, via the selection unit, to park in the parking space having the small inhibitory factor, the vehicle control unit is configured to execute an automated operation of parking into the parking space by causing the user to recognize that parking in the parking space having the small inhibitory factor is being performed.

Another aspect of the present invention is an automated parking method for detecting a parking space around a periphery of a host vehicle, and automatically parking the host vehicle within the detected parking space, the automated parking method comprising: a peripheral environment detection step of detecting a peripheral environment around the periphery of the host vehicle including the parking space and an obstruction within the parking space; a degree of parking obstruction determining step of classifying and determining, based on the peripheral environment around the periphery of the host vehicle detected in the peripheral environment detection step, at least three categories of degree of obstruction when parking of the host vehicle in the parking space is attempted, the categories including a case in which an inhibitory factor is not present and parking is possible, a case in which parking is possible although a small inhibitory factor is present, and a case in which a large inhibitory factor is present and parking is impossible; a selection step of enabling selection by a user of parking in the parking space having no inhibitory factor, or parking in the parking space having the small inhibitory factor; and a vehicle control step of controlling the host vehicle so as to park in the selected parking space, wherein, in the vehicle control step, when the user has selected, via the selection step, to park in the parking space having the small inhibitory factor, an automated operation of parking into the parking space is executed by causing the user to recognize that parking in the parking space having the small inhibitory factor is being performed.

According to the present invention, since the user is capable of selecting whether or not to permit parking in the parking space in which parking is possible although a small inhibitory factor is present, user-friendly automated parking can be performed. More specifically, automated parking can be performed in a parking space while respect is given to the user's intention, without excessively limiting the parking spaces due to the peripheral environment around the periphery of the host vehicle including the obstructions. Accordingly, the scene in which parking is enabled in parking spaces can be expanded based on a judgment made by the user.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing a configuration of a host vehicle to which there is applied an automated parking device according to an embodiment for carrying out an automated parking method according to the embodiment;

FIG. 2 is a flowchart provided in order to describe operations of the automated parking device shown in FIG. 1;

FIG. 3 is a schematic diagram as seen in plan view showing a host vehicle and a portion of a parking lot in which the host vehicle is attempting to park;

FIG. 4 is a diagram showing a degree of parking obstruction classification table;

FIG. 5 is an explanatory diagram of an image provided in order to describe selection units displayed on a display unit; and

FIG. 6 is a schematic diagram as seen in plan view showing a state in which the host vehicle is automatically parked in a selected parking space.

### DESCRIPTION OF THE PREFERRED EMBODIMENTS

Preferred embodiments of an automated parking device and an automated parking method according to the present invention will be presented and described in detail below with reference to the accompanying drawings.

### Embodiments

### [Configuration]

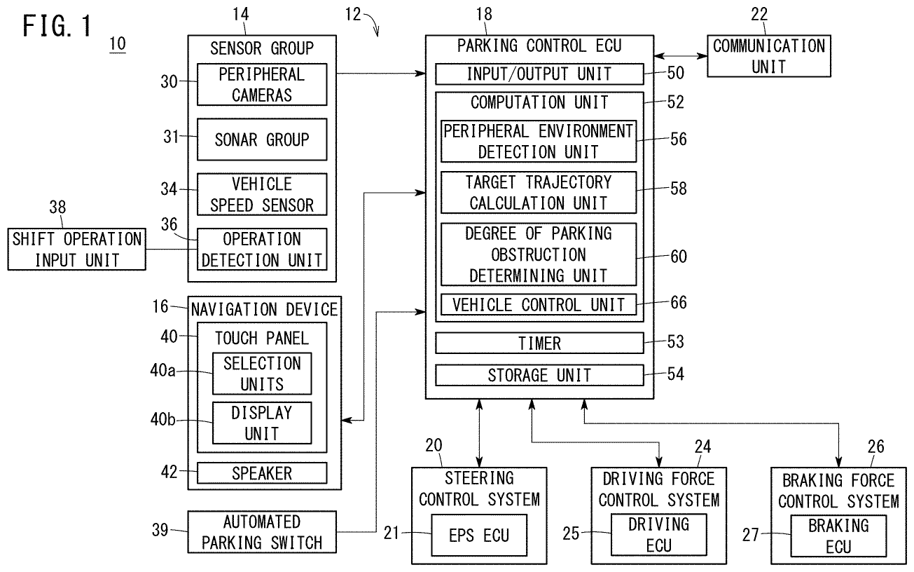

FIG. 1 is a block diagram showing a configuration of a vehicle (host vehicle) 10 to which there is applied an automated parking device 12 according to an embodiment for carrying out an automated parking method according to the embodiment.

As shown in FIG. 1, the automated parking device 12 includes a sensor group 14, a navigation device 16, a parking control ECU (parking control electronic control device) 18, a steering control system 20, a communication unit 22, a driving force control system 24, a braking force control system 26, a shift operation input unit 38, and an automated parking switch 39.

The sensor group 14 acquires various detection values used in connection with the parking control. In the sensor group 14, there are included peripheral cameras (including a front camera, a rear camera, a left side camera, and a right side camera) 30, a sonar group {including a front sonar group (four individual sonars including a left diagonal front sonar, a front left side sonar, a front right side sonar, and a front diagonal sonar), a rear sonar group (four individual sonars including a left diagonal rear sonar, a rear left side sonar, a rear right side sonar, and a right diagonal rear sonar), a left side sonar group (two individual sonars including a left side front sonar and a left side rear sonar), and a right side sonar group (two individual sonars including a right side front sonar and a right side rear sonar)} 31, a vehicle speed sensor 34, and an operation detection unit 36.

The peripheral cameras 30 output, to the parking control ECU 18, signals of peripheral images {a front image, a rear image, and side images (a left side image and a right side image)} obtained by capturing images around the periphery (the front, rear, and sides) of the host vehicle 10.

The sonar group 31 outputs, to the parking control ECU 18, signals of sonar images {a front sonar image, a rear sonar image, and side sonar images (a left side sonar image and a right side sonar image)} in which objects around the periphery (the front, rear, and sides) of the host vehicle 10 are captured by transmitting sound waves around the periphery, together with receiving reflected sound waves from the peripheral objects.

The vehicle speed sensor 34 detects the speed of the host vehicle 10, or stated otherwise, a vehicle speed V, and outputs the detected vehicle speed V to the parking control ECU 18. The vehicle speed sensor 34 can be replaced by wheel speed sensors.

The operation detection unit 36 detects the content of operations performed by a user (driver) using the shift operation input unit 38, and outputs, to the parking control ECU 18, the shift positions (a park position P, a reverse position R, a neutral position N, a forward position D, and a low gear position L) which make up the detected operation content.

Moreover, the shift operation input unit 38 is constituted by a so-called shift-by-wire technology, thus making it possible for an automated shifting operation to be carried out by the parking control ECU 18.

The navigation device 16 detects the current position of the vehicle 10 using, for example, a GPS, and guides the user along a route to the destination. The navigation device 16 includes a storage device equipped with a map information database.

A touch panel 40 and a speaker 42 are provided in the navigation device 16.

The touch panel 40 functions as an input device of the automated parking device 12, for example, selection units 40a, and also functions as a display unit (display device) 40b. A screen related to the parking control is displayed on the display unit 40b. Moreover, constituent elements other than the touch panel 40 may be used as the input device or the display device. Further, when the parking control takes place, as necessary, voice guidance can be performed via the speaker 42.

The automated parking switch (parking initiation instruction unit) 39 outputs, to the parking control ECU 18, an automated parking initiation signal (parking initiation signal) to initiate the automated parking operation of the host vehicle 10 in response to a pressing operation made by the user. The automated parking switch 39 is disposed, for example, at a position on the dashboard where the driver is capable of operating the automated parking switch 39.

Moreover, instead of operating the automated parking switch 39, the driver may output the automated parking initiation signal to initiate the automated parking operation via the touch panel 40. In this case, the touch panel 40 can input and output commands in relation to the parking control.

The parking control ECU 18 includes an input/output unit 50, a computation unit 52, a timer (timekeeping device) 53, and a storage unit 54. The computation unit 52 can be configured, for example, by a CPU. The computation unit 52 executes the parking control by controlling each of the respective units based on programs stored in the storage unit 54.

The computation unit 52 is equipped with a peripheral environment detection unit 56, a target trajectory calculation unit 58, a degree of parking obstruction determining unit 60, and a vehicle control unit 66, which are realized by programs that are stored in the storage unit 54 being executed by the computation unit 52.

The peripheral environment detection unit 56 detects the environment around the periphery of the host vehicle, including the parking spaces around the periphery of the host vehicle 10 and the host vehicle peripheral obstructions, on the basis of the peripheral image signals output from the peripheral cameras 30, and the sonar image signals output from the sonar group 31.

The target trajectory calculation unit 58 calculates a target trajectory from the host vehicle position until entry into the parking space, based on the detected parking spaces, the positions of the obstructions, the host vehicle position, and a vehicle model.

The degree of parking obstruction determining unit 60 classifies and determines, based on the peripheral environment around the periphery of the host vehicle (the size and height of the obstructions, the positions of the obstructions in the parking spaces, or the road surface conditions in the parking spaces) detected by the peripheral environment detection unit 56, at least three categories of degree of parking obstruction (also referred to as degree of obstruction) Pd when parking of the host vehicle in the parking spaces is attempted, the categories including a case in which an inhibitory factor is not present and parking is possible (degree of obstruction A), a case in which parking is possible although a small inhibitory factor is present (degree of obstruction B), and a case in which a large inhibitory factor is present and parking is impossible (degree of obstruction C), and stores the same in the storage unit 54.

In response to the automated parking initiation signal output from the automated parking switch 39, the vehicle control unit 66 cooperatively controls the steering control system 20, the driving force control system 24, and the braking force control system 26, and following along the target trajectory, controls the host vehicle 10 so as to park in one of the parking spaces (automated parking control).

The steering control system 20 is constituted by a steering wheel which is also capable of being operated by the driver, vehicle wheels, and an electric power steering (EPS) device that steers the vehicle wheels in accordance with steering of the steering wheel, and includes an EPS ECU 21. By means of so-called steer-by-wire technology, the EPS ECU 21 makes it possible to automatically steer the vehicle wheels at target steering angles at each of respective vehicle positions on the target trajectory.

The driving force control system 24 includes an engine serving as a driving source, a motor, a transmission, etc., and a driving ECU 25. The driving ECU 25 drives the engine and the motor by so-called driving force-by-wire technology together with controlling the transmission, and by applying the driving force to the vehicle wheels through the transmission, makes it possible to automatically cause the host vehicle 10 to undergo forward movement or be moved in reverse. An accelerator pedal and the shift operation input unit 38 are also configured to allow manual operation thereof by the driver.

The braking force control system 26 includes an electric servo brake serving as a braking source and a braking ECU 27. The braking ECU 27 is capable of automatically applying a braking force to the vehicle wheels by so-called brake-by-wire technology, and thereby causes the host vehicle 10 to stop. A brake pedal is also configured to allow manual operation thereof by the driver.

The communication unit (wireless communication unit) 22 communicates, for example, with a management system inside the parking lot, and obtains position information of the parking spaces (vacant parking frames) within the parking lot from the management system.

### [Operations]

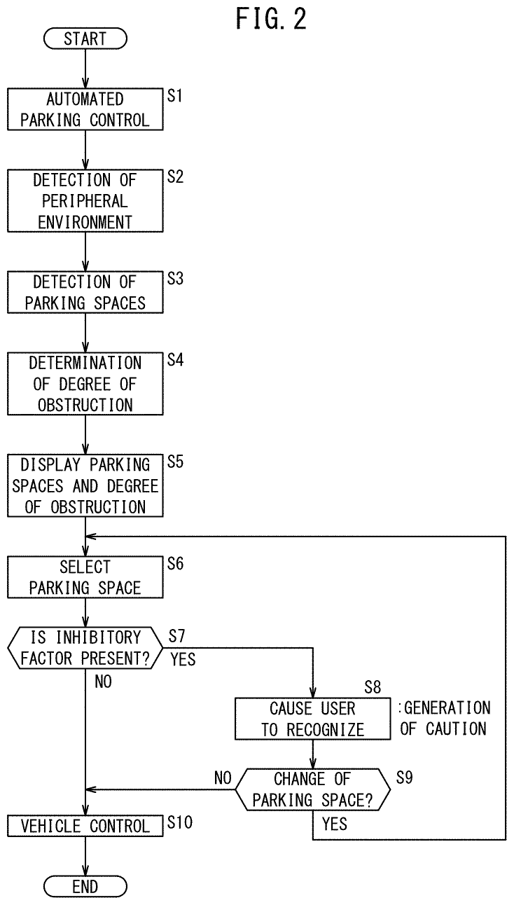

The vehicle 10 to which the automated parking device 12 according to the present embodiment is applied is basically configured in the manner described above. Next, a description will be given with reference to the flowchart shown in FIG. 2 concerning operations of the automated parking device 12.

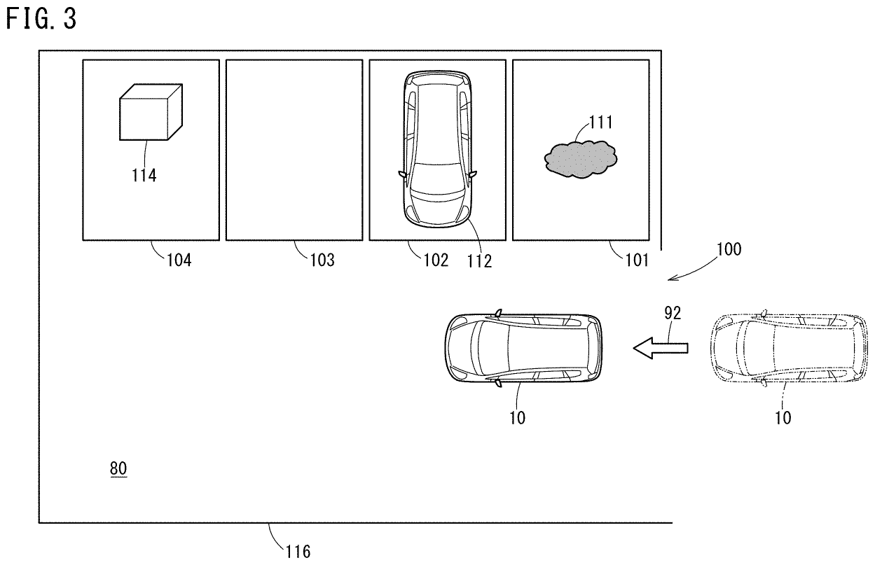

FIG. 3 is a schematic diagram as seen in plan view showing the host vehicle 10, and a portion of a parking lot 80 in which the host vehicle 10 is attempting to park, and which is surrounded by an obstruction 116 such as a fence or a wall.

It is assumed that, while being driven manually by the driver, the host vehicle 10 is driven to an entrance 100 of the parking lot 80, and is stopped at the position indicated by the two-dot-dashed line.

At the position of the two-dot-dashed line, when the automated parking switch 39 is pressed by the driver and the automated parking initiation signal is supplied to the parking control ECU 18, then in step S1, the automated parking control (first, a parking space detection control) by the parking control ECU 18 is initiated.

When the automated parking control is initiated, the host vehicle 10 advances at a slow speed in the direction of an arrow 92 through the driving force control system 24 which is driven by the vehicle control unit 66, and while advancing, a peripheral environment detection process is executed by the peripheral environment detection unit 56 in step S2.

Based on the peripheral image signals output from the peripheral cameras 30 and the sonar image signals output from the sonar group 31, the peripheral environment detection unit 56 detects obstructions 111, 112, 114, and 116 in step S2, and also detects parking spaces 101, 102, 103, and 104 (101 to 104) in step S3.

In this case, the parking spaces 101 to 104 are detected by detecting parking frames such as white line frames.

The contents of the obstructions 111, 112, 114, and 116 detected in step S2 are grasped by a comparison determination of the similarity thereof with obstruction models stored in the storage unit 54. In the present embodiment, the obstruction 111 is grasped as a puddle, the obstruction 112 is grasped as another vehicle, the obstruction 114 is grasped as a cardboard box, and the obstruction 116 is grasped as a fence.

Next, in step S4, the degree of parking obstruction determining unit 60 classifies and determines the degree of parking obstruction Pd of the respective parking spaces 101 to 104, on the basis of the states (occupied states) of the parking spaces 101 to 104, and the contents of the obstructions 111, 112, and 114 existing within the parking spaces 101 to 104.

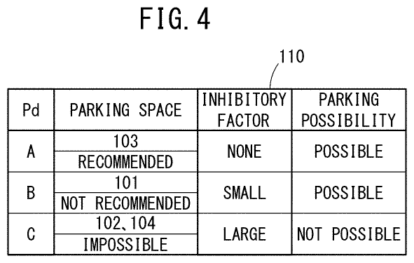

FIG. 4 shows a degree of parking obstruction classification table (classification table) 110 of the results of having classified and determined the degree of parking obstruction Pd, the parking spaces 101 to 104 corresponding to the degree of parking obstruction Pd (Pd=A, B, C), an inhibitory factor, and parking availability (i.e., whether or not parking is possible). The degree of parking obstruction classification table 110 is stored in the storage unit 54.

In this case, based on the peripheral environment of the vehicle detected by the peripheral environment detection unit 56, the degree of obstruction Pd when the host vehicle 10 attempts to park in the parking spaces 101 to 104 is classified and determined to be in at least three categories, including a degree of obstruction A for a case in which an inhibitory factor is not present and parking is possible, a degree of obstruction B for a case in which parking is possible although a small inhibitory factor is present, or a degree of obstruction C for a case in which a large inhibitory factor is present and parking is impossible.

The parking space 103 that is classified as being of the degree of obstruction A does not have any inhibitory factor therein, and is classified and determined to be a parking space which is recommended and in which parking is possible.

The parking space 101 that is classified as being of the degree of obstruction B has the obstruction 111 (a puddle) therein regarded as a small inhibitory factor, and is classified and determined to be a parking space in which, although not recommended, parking is possible. Although not illustrated, also in the case of an obstruction having a moderate height which the host vehicle 10 is capable of easily passing over, or in the case of the curvature and irregularity of the road surface which the host vehicle 10 is capable of traveling thereover, such a parking space is classified and determined to be a parking space of the degree of obstruction B in which, although not recommended, parking is possible. The curvature and irregularity of the road surface in the surrounding vicinity of the host vehicle 10 can be suitably detected by the sonar group 31.

The parking spaces 102 and 104 that are classified as being of the degree of obstruction C have a large inhibitory factor (large in size, high in height, located in the vicinity of the center of the parking space) therein, respectively, such as the obstruction 112 (another vehicle) and the obstruction 114 (a cardboard box), and are classified and determined to be parking spaces in which parking is not possible. Moreover, although not illustrated, in the case of a road surface having a large cavity or recess therein, the parking space is classified and determined to be a parking space in which parking is not possible.

By the host vehicle 10 shown in FIG. 3 traveling from the position of the two-dot-dashed line to the position of the solid line, the positions of all of the parking spaces 101 to 104 inside the parking lot 80 can be viewed without obstruction by the peripheral cameras 30 and the sonar group 31, and with respect to all of the parking spaces 101 to 104, the degree of parking obstruction classification table 110 is created. Therefore, through the braking force control system 26, the host vehicle 10 is temporarily stopped at the position of the solid line.

Next, in step S5, the degree of parking obstruction determining unit 60 schematically displays, on the display unit 40b of the navigation device 16, a plan view image (an image based on the parking spaces and the degree of obstruction Pd therein) of the parking lot 80 in the vicinity of the host vehicle 10.

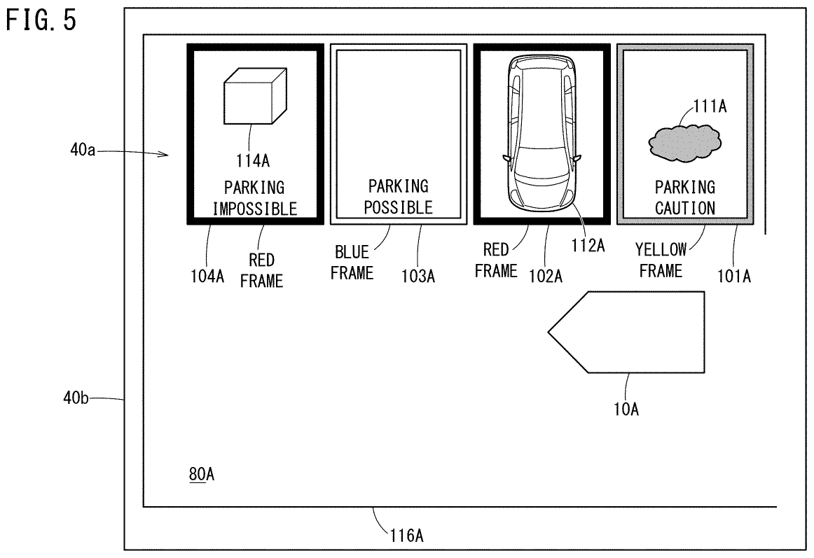

FIG. 5 is a schematic view in which there is shown, on the display unit 40b, a plan view image (partially including a still image obtained from a video image) 80A of the parking lot, in which images 101A to 104A of the parking spaces 101 to 104 and an image 10A of the host vehicle 10 are displayed inside an image 116A of the fence.

A parking frame, which is the parking space 104 (image 104A) classified and determined as the degree of parking obstruction C and in which an image 114A of a cardboard box and the characters “parking impossible” are displayed inside the parking frame, is displayed by a red frame.

A parking frame, which is the parking space 103 (image 103A) classified and determined as the degree of parking obstruction A and in which there is no obstruction and the characters “parking is possible” are displayed inside the parking frame, is displayed by a blue frame (or a green frame).

A parking frame, which is the parking space 102 (image 102A) classified and determined as the degree of parking obstruction C and in which an image 112A of another vehicle is displayed inside the parking frame, is displayed by a red frame.

A parking frame, which is the parking space 101 (image 101A) that is classified and determined as the degree of parking obstruction B and in which an image 111A of a puddle and the characters “parking caution” are displayed inside the parking frame, is displayed by a yellow frame (a yellow colored frame or an orange frame). The regions within the red frame, the blue frame, and the yellow frame serve dually as the selection units 40a.

More specifically, in step S6, a parking space is selected by the user touching one of the selection units 40a (in this case, the region within the blue frame or the yellow frame).

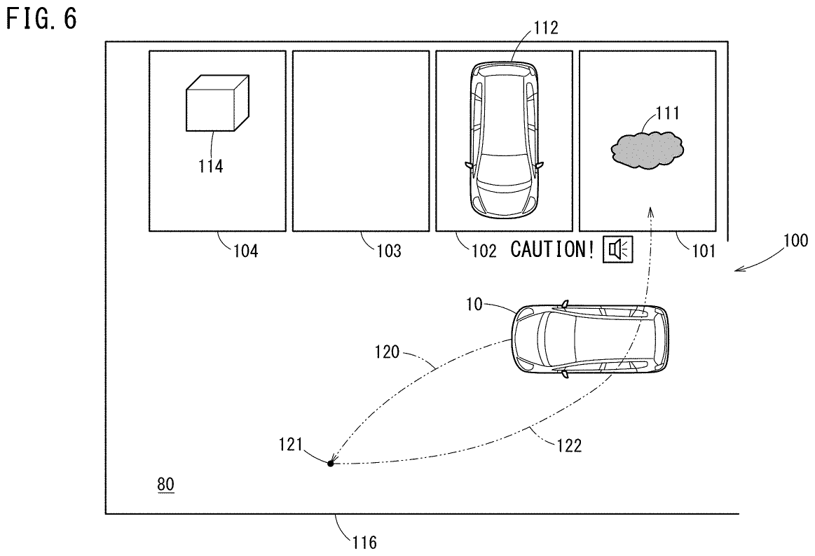

In step S6, in the case that the user selects the parking space 101 (the region inside the image 101A) indicated by the yellow frame in the vicinity of the entrance 100, then in step S7, the vehicle control unit 66 determines that the parking space 101 has an inhibitory factor (step S7: YES), and in step S8, as shown schematically in FIG. 6, the vehicle control unit 66 generates, through the speaker 42, a caution (see FIG. 6) which causes the user to recognize that “You are attempting to park in a parking position having a puddle.”

In the case that the user has not changed the selection of the parking space 101 in step S9 despite the caution, then in step S10, as shown in FIG. 6, the target trajectory calculation unit 58 calculates target trajectories 120 (a forward left steering trajectory), 121 (a turn-about stop position trajectory), and 122 (a rearward right steering trajectory) from the current position of the host vehicle 10 until entry into the parking space 101, based on the selected parking space 101, the positions of the obstructions 112 and 116, the position of the host vehicle 10, and the vehicle model of the host vehicle 10, and executes an automated driving control (automated parking control) for the host vehicle 10 along the calculated target trajectories 120, 121, and 122, and causes the host vehicle 10 to move in a rearward direction into the parking space 101 and come to a stop.

On the other hand, in step S6, in the case that the user has selected the parking space 103 (the region inside the image 103A) indicated by the blue frame on the inner side of the parking lot 80, or alternatively, after generation of the caution in step S8, in the case that the user has not changed to the parking space 103 (the region inside the image 103A) indicated by the blue frame in step S9, then in step S10, the target trajectory calculation unit 58 calculates a target trajectory (not shown) for entry into the parking space 103. The vehicle control unit 66 performs an automated driving control (automated parking control) for the host vehicle 10 along the target trajectory, and causes the host vehicle 10 to come to a stop inside the parking space 103. In the case that the parking space is changed in step S9, the process returns to step S6.

### SUMMARY

The automated parking device 12 according to the present embodiment detects the parking spaces 101 to 104 around the periphery of the host vehicle 10, and automatically parks the host vehicle 10 within the detected parking spaces 101 to 104, the automated parking device 12 comprising: the peripheral environment detection unit 56 configured to detect the peripheral environment around the periphery of the host vehicle including the parking spaces 101 to 104 and the obstructions 111, 112, and 114 within the parking spaces 101 to 104; the degree of parking obstruction determining unit 60 configured to classify and determine, based on the peripheral environment around the periphery of the host vehicle detected by the peripheral environment detection unit 56, at least three categories of degree of obstruction Pd when parking of the host vehicle 10 in the parking spaces 101 to 104 is attempted, the categories including a case in which an inhibitory factor is not present and parking is possible (degree of obstruction A), a case in which parking is possible although a small inhibitory factor is present (degree of obstruction B), and a case in which a large inhibitory factor is present and parking is impossible (degree of obstruction C); the selection units 40a configured to enable selection by a user of parking in the parking space 103 having no inhibitory factor, or parking in the parking space 101 having the small inhibitory factor; and the vehicle control unit 66 configured to control the host vehicle 10 so as to park in the parking space 101 or 103 that is selected, wherein, when the user has selected, via the selection units 40a, to park in the parking space 101 having the small inhibitory factor, the vehicle control unit 66 is configured to execute the automated operation of parking into the parking space 101 by causing the user to recognize that parking in the parking space 101 having the small inhibitory factor is being performed.

In the manner described above, since a configuration is provided in which the user is capable of selecting whether or not to permit parking in the parking space 101 in which parking is possible although the small inhibitory factor is present, user-friendly automated parking can be performed. More specifically, automated parking can be performed in the parking space 101 or 103 while respect is given to the user's intention, without excessively limiting the parking space 101 due to the peripheral environment around the periphery of the host vehicle including the obstruction 111. Accordingly, the scene in which parking in the parking space 101 is enabled can be expanded based on the judgment made by the user.

In this case, the automated parking device 12 is further provided with the display unit 40b, wherein, when causing the user to recognize that parking in the parking space 101 having the small inhibitory factor is being performed, the vehicle control unit 66 is configured to display the content (obstruction image 111A, see FIG. 5) of the small inhibitory factor on the display unit 40b.

Consequently, since the content (obstruction image 111A) of the small inhibitory factor is displayed on the display unit 40b, information concerning the parking space 101 can be conveyed to the user in an easily understandable manner.

Further, the automated parking device 12 is further provided with the display unit 40b, wherein the degree of parking obstruction determining unit 60 is configured to display, on the display unit 40b, information on the degree of obstruction Pd (Pd=A, B, or C) that is classified and determined to be in the three categories, the information being displayed in a superimposed manner with the detected parking spaces 101 to 104 (see FIG. 5).

In this manner, since the information on the degree of obstruction Pd that is classified and determined to be in the three categories is displayed together with the images 101A to 104A of the parking spaces displayed on the display unit 40b, the information concerning the parking spaces 101 to 104 can be conveyed to the user in an easily understandable manner.

In this case, the degree of parking obstruction determining unit 60 is configured to display, on the display unit 40b, the information on the degree of obstruction Pd (Pd=A, B, C) that is classified and determined to be in the three categories, the information being displayed in different colors (see FIG. 5: parking impossible is shown with a red frame, parking possible is shown with a blue frame, and parking caution is shown with a yellow frame, or the like).

In the foregoing manner, since the information concerning the degree of obstruction Pd (Pd=A, B, C) that is classified and determined to be in the three categories is displayed in different colors on the display unit 40b, it is possible to convey the information of the parking spaces 101 to 104 in a more easily understandable manner conforming to the user's sensibility (i.e., a sensibility of recognizing a green colored traffic signal indicating proceed, a yellow colored traffic signal indicating caution, and a red colored traffic signal indicating stop).

Moreover, the degree of parking obstruction determining unit 60 is configured to classify and determine the degree of obstruction (degree of parking obstruction) Pd based on the size or the height of the obstructions 111, 112, and 114, or the positions of the obstructions 111, 112, and 114 within the parking spaces 101, 102, and 104.

In accordance with this feature, since the degree of obstruction (degree of parking obstruction) Pd is classified and determined based on the size or the height of the obstructions 111, 112, and 114, or the positions of the obstructions 111, 112, and 114 within the parking spaces 101, 102, and 104, it is possible to accurately determine the degree of obstruction Pd (Pd=A, B, C).

The degree of parking obstruction determining unit 60 is configured to classify and determine the degree of parking obstruction Pd based on road surface conditions within the parking spaces 101 to 104.

In accordance with this feature, since the degree of parking obstruction Pd is classified and determined based on the road surface conditions within the parking spaces 101 to 104, the degree of obstruction Pd (Pd=A, B, C) can be accurately determined.

The automated parking method according to the present embodiment detects the parking spaces 101 to 104 around the periphery of the host vehicle 10, and automatically parks the host vehicle 10 within the detected parking spaces 101 to 104, the automated parking method comprising: the peripheral environment detection step S2 of detecting the peripheral environment around the periphery of the host vehicle including the parking spaces 101 to 104 and obstructions 111, 112, and 114 within the parking spaces 101 to 104; the degree of parking obstruction determining step S4 of classifying and determining, based on the peripheral environment around the periphery of the host vehicle detected in the peripheral environment detection step S2, at least three categories of degree of obstruction Pd when parking of the host vehicle 10 in the parking spaces 101 to 104 is attempted, the categories including a case in which an inhibitory factor is not present and parking is possible (degree of obstruction A), a case in which parking is possible although a small inhibitory factor is present (degree of obstruction B), and a case in which a large inhibitory factor is present and parking is impossible (degree of obstruction C); the selection step S6 (S9) of enabling selection by the user of parking in the parking space 103 having no inhibitory factor, or parking in the parking space 101 having the small inhibitory factor; and the vehicle control step S10 of controlling the host vehicle 10 so as to park in the parking space 101 or 103 that is selected, wherein, in the vehicle control step S10, when the user has selected, via the selection step S6 or S9, to park in the parking space 101 having the small inhibitory factor, an automated operation of parking into the parking space 101 is executed by causing the user to recognize that parking in the parking space 101 having the small inhibitory factor is being performed.

In the manner described above, since the selection steps S6 and S9 are provided by which the user is capable of selecting whether or not to permit parking in the parking space 101 in which parking is possible although the small inhibitory factor is present, user-friendly automated parking can be performed. More specifically, automated parking can be performed in the parking space 101 or 103 while respect is given to the user's intention, without excessively limiting the parking space 101 due to the peripheral environment around the periphery of the host vehicle including the obstruction 111. Accordingly, the scene in which parking in the parking space 101 is enabled can be expanded based on the judgment made by the user.

The present invention is not limited to the above-described embodiments, but it goes without saying that various additional or alternative configurations could be adopted therein based on the content disclosed in the present specification.

What is claimed is:

1. An automated parking device that detects a parking space around a periphery of a host vehicle, and automatically parks the host vehicle within the detected parking space, the automated parking device comprising:
a peripheral environment detection unit configured to detect a peripheral environment around the periphery of the host vehicle including the parking space and an obstruction within the parking space;
a degree of parking obstruction determining unit configured to classify and determine, based on the peripheral environment around the periphery of the host vehicle detected by the peripheral environment detection unit, at least three categories of degree of obstruction when parking of the host vehicle in the parking space is attempted, the categories including a case in which an inhibitory factor is not present and parking is possible, a case in which parking is possible although a small inhibitory factor is present, and a case in which a large inhibitory factor is present and parking is impossible;
a selection unit configured to enable selection by a user of parking in the parking space having no inhibitory factor, or parking in the parking space having the small inhibitory factor; and
a vehicle control unit configured to control the host vehicle so as to park in the selected parking space,
wherein, when the user has selected, via the selection unit, to park in the parking space having the small inhibitory factor, the vehicle control unit is configured to execute an automated operation of parking into the parking space by causing the user to recognize that parking in the parking space having the small inhibitory factor is being performed.

2. The automated parking device according to claim 1, further comprising a display unit, wherein, when causing the user to recognize that parking in the parking space having the small inhibitory factor is being performed, the vehicle control unit is configured to display content of the small inhibitory factor on the display unit.

3. The automated parking device according to claim 1, further comprising a display unit, wherein the degree of parking obstruction determining unit is configured to display, on the display unit, information on the degree of obstruction that is classified and determined to be in the three categories, the information being displayed in a superimposed manner with the detected parking space.

4. The automated parking device according to claim 3, wherein the degree of parking obstruction determining unit is configured to display, on the display unit, the information on the degree of obstruction that is classified and determined to be in the three categories, the information being displayed in different colors.

5. The automated parking device according to claim 1, wherein the degree of parking obstruction determining unit is configured to classify and determine the degree of obstruction based on a size or a height of the obstruction, or a position of the obstruction within the parking space.

6. The automated parking device according to claim 1, wherein the degree of parking obstruction determining unit is configured to classify and determine the degree of obstruction based on a road surface condition within the parking space.

7. An automated parking method for detecting a parking space around a periphery of a host vehicle, and automatically parking the host vehicle within the detected parking space, the automated parking method comprising:
a peripheral environment detection step of detecting a peripheral environment around the periphery of the host vehicle including the parking space and an obstruction within the parking space;
a degree of parking obstruction determining step of classifying and determining, based on the peripheral environment around the periphery of the host vehicle detected in the peripheral environment detection step, at least three categories of degree of obstruction when parking of the host vehicle in the parking space is attempted, the categories including a case in which an inhibitory factor is not present and parking is possible, a case in which parking is possible although a small inhibitory factor is present, and a case in which a large inhibitory factor is present and parking is impossible;
a selection step of enabling selection by a user of parking in the parking space having no inhibitory factor, or parking in the parking space having the small inhibitory factor; and
a vehicle control step of controlling the host vehicle so as to park in the selected parking space;
wherein, in the vehicle control step, when the user has selected, via the selection step, to park in the parking space having the small inhibitory factor, an automated operation of parking into the parking space is executed by causing the user to recognize that parking in the parking space having the small inhibitory factor is being performed.
